(19) United States
(12) Patent Application Publication
(10) Pub. No.: US 2026/0252491 A1
(43) Pub. Date: Aug. 27, 2026

(54) Method and System for Operating a Lookaside Distributed Processing Unit

(71) Applicant: Kenyi Technologies, Inc,, Piscataway, NJ (US)

(72) Inventors: Vincent Loncke, Piscataway, NJ (US); Sean Hart, Freehold, NJ (US); Benjamin Tang, New York, NY (US); Paul Atilola, Port Reading, NJ (US)

(21) Appl. No.: 19/423,527

(22) Filed: Dec. 17, 2025

Related U.S. Application Data
(60) Provisional application No. 63/734,852, filed on Dec. 17, 2024.

(51) Int. Cl. G06F 12/0815; G06F 17/16

(52) U.S. Cl. CPC G06F 12/0815; G06F 17/16

(57) ABSTRACT

A integrated circuit architecture for a distributed unit computing solution that utilizes virtualized L1 software for virtual acceleration modules, while having energy, capacity and cost efficiencies approaching the in-line hardware acceleration architectures. The unit utilizes coherent and non-coherent fabrics for optimizing performance and device design.

### PRIORITY CLAIM

This is a Utility patent application that claims priority to and incorporates by reference U.S. Prov. App. No. 63/734,852 filed on Dec. 17, 2024. This application incorporates by reference the Appendix to the Specification filed with U.S. Prov. App. No. 63/734,852.

### FIELD OF INVENTION AND BACKGROUND

This invention relates to a Data Processing Unit (DPU), processor that typically offloads networking, security, and storage functions from the central processing unit architecture.

### SUMMARY

The Kenyi Technologies Lookaside Distributed Unit (DU) solution utilizes a virtualized L1 SW while having energy, capacity and cost efficiencies approaching the Inline KPIs. Such an approach will allow the same platform to apply to cost sensitive Distributed RAN (DRAN) deployments with the ability to efficiently scale to higher capacity Central/Cloud RAN (CRAN) deployments, all from the same SW platform. There are three basic components:
1. Portable L1 SW (incl. ARM compatibility)
2. A lookaside accelerator SoC (Kenyi Technologies VRAN Lookaside DPU) that can be integrated with a host multi-core CPU in either Chiplet or PCIE plug in form factors.
3. AI native processing leveraging that the math processing necessary for L1 is similar to processing needed for AI Inferencing and that a carefully designed accelerator architecture can opportunistically support both.

### VRAN Lookaside DPU Feature Summary

This section summarizes a subset of the innovative highlights of the Kenyi Technologies VRAN Lookaside DPU.
DPU architecture tailored to a VRAN Lookaside use case that runs L1 dataplane SW in a host CPU, while offloading L1 RAN specific functions to the DPU along with Fronthaul (ORAN compliant) networking and AI/ML inferencing. The DPU architecture can mate to a host in a PCIe plug-in formfactor or a chiplet single package configuration.
Heterogeneous architecture which can facilitate disaggregation of DPU subsystems in granular chiplets which can be repurposed to verticals other than telco (e.g. auto, networking, AI inferencing).
Flexible chiplet configurations to support both PCIe plug-in or single package Host+DPU configurations. The latter will be supported by implementing a RCiEP and MMU on top of a CHI C2C+UCIe interface. To support the PCIe plug-in formfactor a chiplet will be connected that implements PCIe SERDES with the option of a PCIe controller residing in such a chiplet or use of the RCiEP controller in the DPU die (RCiEP controller can consist of a PCIe endpoint controller).
Support for a CHI C2C+UCIe interface that connects a coherent fabric (e.g. CHI) for a CPU cluster in a host chiplet to a coherent fabric for a CPU cluster in the DPU chiplet. Such a connection enables a coherent view of caches and DDR memory across chiplets. This will enable the CPU cluster in the DPU to seamlessly extend the CPU processing capability in the host. It will also enable uniform access to DDR and shared cache from either the host or the DPU chiplet for memory regions that can be private or shared and coherent between the host and DPU chiplets. DDR memory channels can physically reside in the host and/or the DPU with seamless access from the host and/or DPU. While DDR memory is a preferred embodiment, other physical memory configurations may be used for example, HBM or SRAM. All of these are forms of physical data memory. Physical memory can be attached to the system through a first coherent fabric, a second coherent fabric or both coherent fabrics.
The DPU+Host chiplet configuration can leverage either private DDR and cache and/or shared DDR and shared cache for HARQ and buffer storage for the RAN Accelerator Subsystem and the other subsystems in the DPU. The DDR and cache footprint can be used to chain together processing stages in the DPU without a hop through the host multiple CPU cores. For instance, equalization output from the accelerator in the DPU can be fed directly to the LDPC chain through a buffer either internal to the DPU or in DDR or in shared cache.
Implementation of an Event Device Engine in the DPU chiplet for event scheduling of CPU cores in the host and/or the DPU CPU cluster. The Engine will be implemented in SW on the DPU CPU cluster and/or in a HW module. The Event Device will support virtualization. The CPU function can be implemented as one or more CPU cores, as a multi-core CPU of which some CPU cores attached to the system through a first coherent fabric while others may attach through a second coherent fabric.
A Lookaside Queuing Subsystem for managing task descriptors and dataflows between the host and the DPU. The RAN accelerators, FH Networking, Crypto acceleration and AI/ML/DSP functionality all need to support virtualization. In a lookaside VRAN system, management of multiple streams of descriptors and data between the host and the heterogeneous collection of functions supported in the DPU is needed. Each stream should represent an isolated service being provided by the specific shared function in the DPU to a client in the host as opposed to an Inline VRAN system where functions are chained together with proprietary and closed interfaces between functional stages.
Real Time-RIC applications as well as AI-on-RAN and AI-for-RAN applications will require inferencing capabilities. Cost sensitive deployments can't afford expensive GPU's or other expensive AI/ML inferencing systems. Integrating an inferencing capability in a Lookaside DPU enables a range of AI/ML enabled applications in the RIC in a cost-effective manner.
The Fronthaul CPU+NIC contains acceleration for general networking as well as ORAN fronthaul specific functions such as ORAN (de) compression and parsing and insertion of the ORAN headers. The Fronthaul NIC, disaggregated into its own chiplet, can also be repurposed to additional verticals that may require networking acceleration in a chiplet form factor (e.g. automotive, general networking, AI/ML etc.).

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1: Exemplary System Architecture

FIG. 2: Architecture of Queueing Subsystem

FIG. 3A: Protocol Diagram for Queuing Subsystem, First Part

FIG. 3B: Protocol Diagram for Queueing Subsystem, Second Part

FIG. 4: Diagram showing mapping of a Wireless Baseband algorithm to an AI/ML inferencing process.

FIG. 5: Example Radiation Hardened Application.

FIG. 6: Diagram showing Fabric Extension Architecture

FIG. 7: Diagram showing DPU with Math Accelerator

FIG. 8: Diagram showing Host multicore CPU processing extension through DPU to Math accelerator.

FIG. 9: Table of Matrix processing functions.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

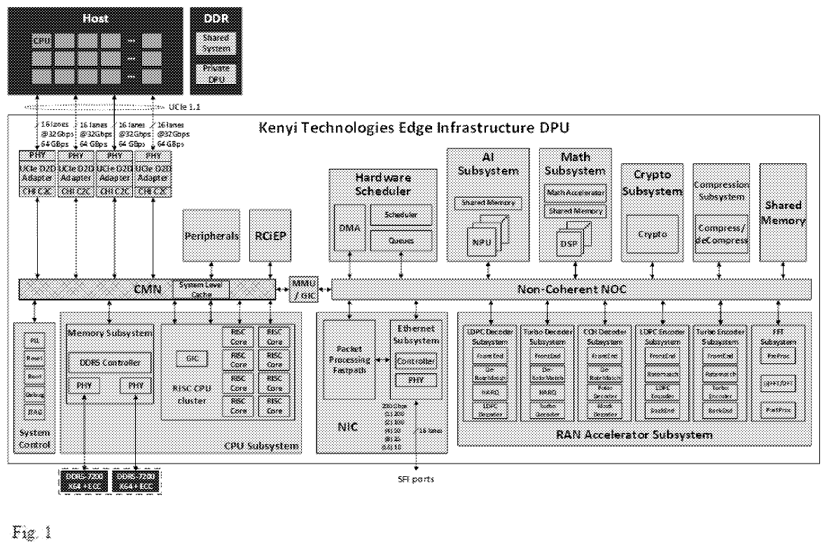

Architecture: FIG. 1 illustrates a high-level block diagram of the Kenyi Technologies VRAN Lookaside DPU. The SoC contains the following major components:
Host Interface-UCIe interfaces for streaming data between Host and DPU:
   UCIe Interface's with CHI C2C, MMU and RCiEP for Virtualized IO Accelerator access
   UCIe Interface's with CHI C2C for private access to Host attached DDR
   UCIe interfaces to be implemented in either Dual Module configuration or as a pair of single modules [8] [9]
Lookaside Queuing Subsystem—Queuing subsystem managing arbitration and QOS of flows into and out of accelerators
Event Device Engine—Event Scheduler for scheduling multicore dataplane workflows
RAN Accelerator Subsystem—Containing processing chains for the following Baseband Accelerators:
   LDPC Decoder Subsystem—De-ratematching, HARQ, LDPC Decoding
   LDPC Encoder Subsystem—CB segmentation, Ratematching, LDPC Encoding
   CCH Decoder Subsystem—De-ratematching, Polar Decoding, Block Decoding
   Turbo Decoder Subsystem—De-ratematching, HARQ, Turbo Decoding
   Turbo Encoder Subsystem—CB segmentation, Ratematching, Turbo Encoding
   FFT Subsystem
AI Accelerator Subsystem—Dual use for Wireless baseband acceleration and general-purpose Inferencing
CPU Subsystem—Octa-core N2 ARM Cluster for ORAN Fronthaul and other offload processing
   Other options implementing ARM or RISC-V ISA can be considered
Fronthaul NIC—Packet Processing Accelerators and Ethernet MAC for ORAN Fronthaul
Crypto Accelerator Subsystem—SHA, AES, ZUC

Lookaside Queuing Subsystem: To support parallel processing of the baseband workload within a VM, the Kenyi VRAN Lookaside DPU implements a Queuing Subsystem that manages the ingress and egress of pointers, descriptors, data and status between the Host and the DPU. The Queuing subsystem (see FIG. 1) has management logic for each VF that manages QOS, notifications and statistics, as well as a series of queues to buffer and dejitter the pointers, descriptors, data and status between the shared functions implemented in the DPU and the processing in the VM/Container that are partitioned along the aforementioned degrees of freedom as well as other partitioning mechanisms to provide multicore processing efficiency and speedup.

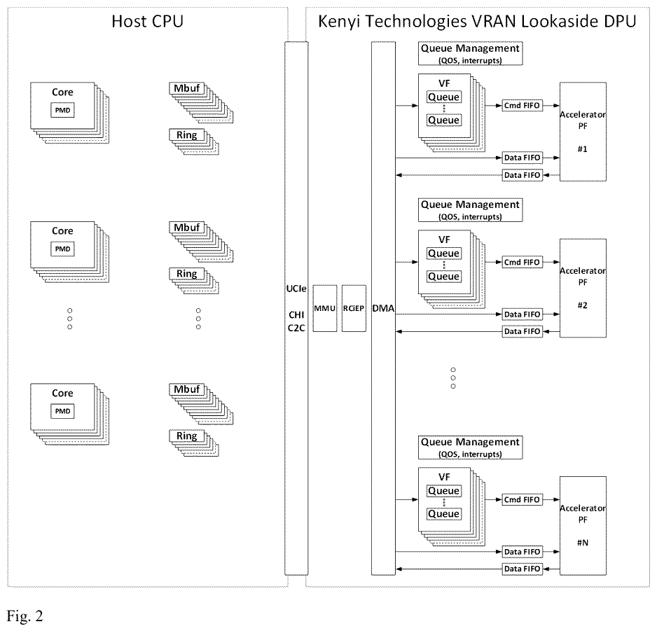

A Lookaside Queuing Subsystem for managing task descriptors and dataflows between the host and the DPU. The RAN accelerators, FH Networking, Crypto acceleration and AI/ML/DSP functionality all need to support virtualization. In a lookaside VRAN system, management of multiple streams of descriptors and data between the host and the heterogeneous collection of functions supported in the DPU is needed. Each stream should represent an isolated service being provided by the specific shared function in the DPU to a client in the host as opposed to an Inline VRAN system where functions are chained together with proprietary and closed interfaces between functional stages. See FIG. 2.

As opposed to an Inline VRAN Accelerator, where the interfaces between processing stages and accelerator blocks are internal to the Inline Accelerator, the Lookaside Queuing Subsystem in the Kenyi VRAN Lookaside DPU orient the interfaces between processing stages and accelerator blocks to go between the Host CPU (and its Host memory) and the DPU connected to the host through a virtualized IO interface. Such an orientation is fundamental to Lookaside functionality between the Host and the accelerators in the Kenyi VRAN Lookaside DPU.

Host CPU memory hierarchy includes the DDR memory, system level L3 cache and the cores'L1 and L2 caches. Memory pools (“mempool”) are allocated at initialization time so that memory buffers (“mbuf”) can be taken or returned to the mempool during runtime. A mempool is allocated for data buffers that can be worked on by the worker cores or for data to be transferred in and out of the accelerators. Another mempool can be allocated for accelerators'operation data packets that contain pointers to data buffers and ops parameters. Accelerators'DMA descriptor queues (in “acc_queue”) are used to queue up DMA descriptor packets (“acc_dma_desc”) that are written to or updated from the accelerators.

To transfer data from the host to the accelerator, the PMD core creates the ops data packet (e.g.: dpdk_op_accX), packs the ops data into a DMA descriptor packet and performs a cache flush to DDR. The accelerator fetches the DMA descriptor packet, finds out from the DMA descriptor the location of the datain mbuf in DDR, fetches the datain mbuf, processes it, DMAs the result to the dataout mbuf and updates the status in the DMA descriptor. If the next stage processing is by the worker cores, the dataout mbufshould then be prefetched by the PMD core from DDR to L3 cache to speed up the fetching of data into the worker cores'L1/L2 caches.

When a worker core is done processing an mbuf, it should perform a cache flush either to DDR if the next stage processing is by the accelerator, or to L3 cache if the next stage processing is by other worker cores.

The ‘Acc memory’ in the DPU represents storage for descriptor and data queuing and FIFO's in the DPU.

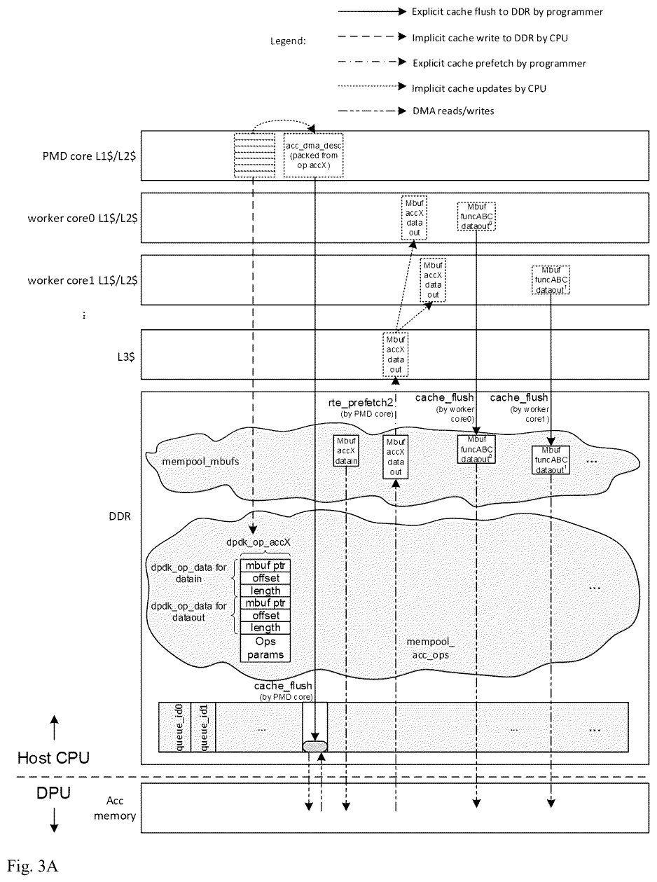

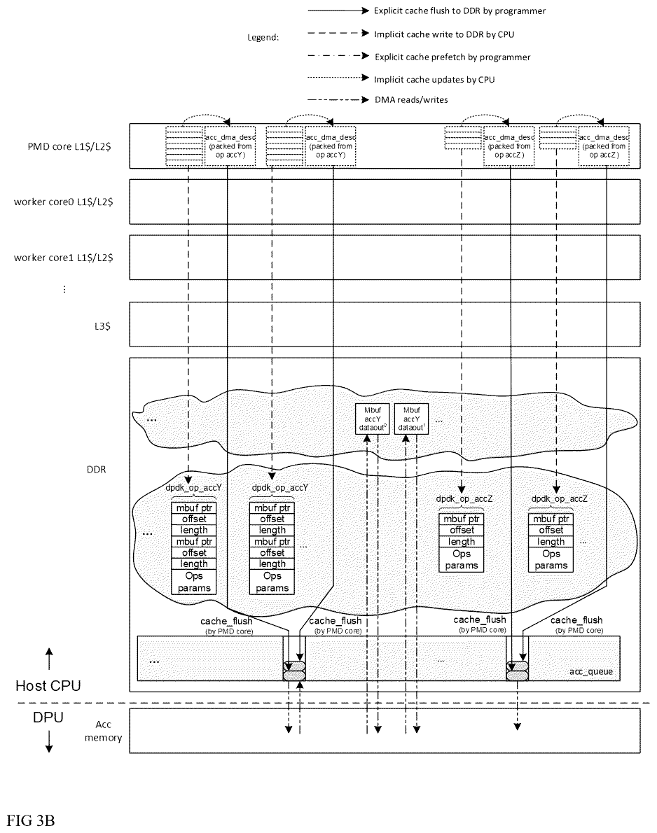

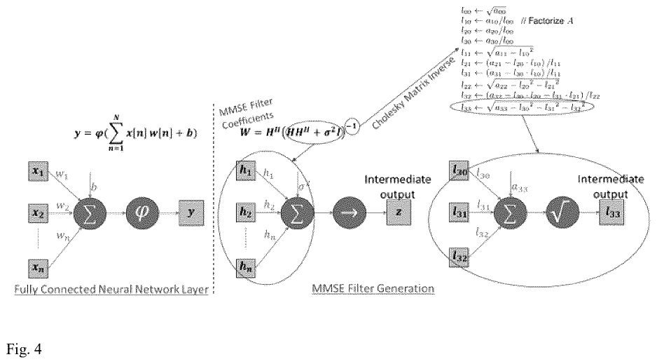

The Lookaside Queuing Subsystem serves as the interface between the Host and the Physical functions in the DPU. FIGS. 3A and 3B illustrates the SW Flow between the Host CPU and the DPU. Time is from left to right. The double dash arrows represent concurrent flows on the ingress and egress of the DPU. These flows are managed by a multichannel DMA in the Lookaside Queuing Subsystem in the Kenyi VRAN Lookaside DPU. SW drivers in the host prepare descriptors for the virtual accelerated functions in the DPU (acc_dma_desc in FIG. 3). SW drivers also prepare/consumes data in host memory (mbuf's in FIG. 3) that is consumed/returned by the DPU. The movement of the descriptors and the data is managed by the Lookaside Queuing Subsystem across logical streams within a virtual machine and across virtual machines (double dash arrows in FIG. 3). The ‘acc_queue’ is a buffer in the DDR memory that holds the descriptors that go into the DPU below. The descriptors tell the DPU what to do with the data in the mempool_mbufs. The acc memory is in the DPU. The Acc memory and the VF queues are physically the same thing because the queues are implemented in the memory. For clarity, note that the ACC Memory in the DPU in the protocol diagram is an abstraction meant to represent the VF queue and data FIFO's in the VRAN diagram of FIG. 4. Note that the PMD and worker cores in the protocol diagram are labeled ‘Core’ in the VRAN diagram. This is because the “core” in the VRAN architecture diagram (FIG. 4) is a hardware processor core, whereas the core in the protocol diagram is a virtual core role that gets assigned to the processor core (i.e. as a worker or PMD). There are many such virtual roles in the system and the roles are interchangeable and redefinable dynamically.

AI/ML Inferencing Acceleration: Expensive GPUs are not an option for cost sensitive DRAN deployments, thus an inferencing capability in the Kenyi Technologies VRAN Lookaside DPU to offload AI/ML inferencing from the Host in a cost effective manner can be justified. Such an inferencing capability can leverage upon the fact that the Kenyi VRAN Lookaside DPU will implement mathematical processing for Wireless Baseband functions such as Maximum Likelihood Sphere Decoder and MMSE. These Baseband functions require Digital Signal Processing (DSP) that is similar in nature to AI/ML inferencing processing. This potentially allows for reuse and sharing of processing elements internal to the DPU for both use cases. FIG. 4 illustrates MMSE (potential Baseband function) mapped on to a fully connected Neural Network (NN) layer used as a building block for AI/ML inferencing. FIG. 4 shows that HW processing resource sharing between a baseband function like MMSE and AI/ML inferencing on a Fully Connected NN.

The ORAN standard implements the Non-Real Time and Near-Real Time RAN Intelligent Controller (Non-RT RIC, Near-RT RIC) as a mechanism to host applications that optimize RAN functionality. The RIC architecture and interfaces facilitate AI/ML enablement for these applications by providing interfaces and facilities to support AI/ML training and inferencing. The Non-RT RIC is meant to provide control in a feedback loop with the airlink of >1 s. The Near-RT RIC supports loop latencies of 10 ms to 1 ms. Given 5G airlink slot times of 500 us to 125 us and the fact that the Non-RT and Near-RT RICs operate on a slower timescale, the Near-RT and especially the Non-RT RIC are meant to be implemented on processing in the CU which can reside remote from the DU where the baseband processing occurs (and for which the Kenyi VRAN Lookaside DPU will reside). Given that the CU sits further back in the network, and its processing does not have as much a stringent latency requirement as in the DU, there is more of an opportunity to pool CU processing on COTS Server HW and to incorporate COTS HW for AI/ML training and inferencing (for the Non-RT and Near-RT RICs) such as GPU's. Different embodiments of the invention will combine artificial intelligence processes (AI) with RAN functionalities. In one, referred to as AI-on-RAN, the system will operate AI applications on RAN infrastructure using RAN connectivity. In another, referred to as AI-for-RAN, the AI processes operate to control the RAN in order to improve its performance. In yet a third, referred to as AI-and-RAN, the system utilizes efficient computing architectures for operating both RAN processes and AI processes on the same hardware infrastructure.

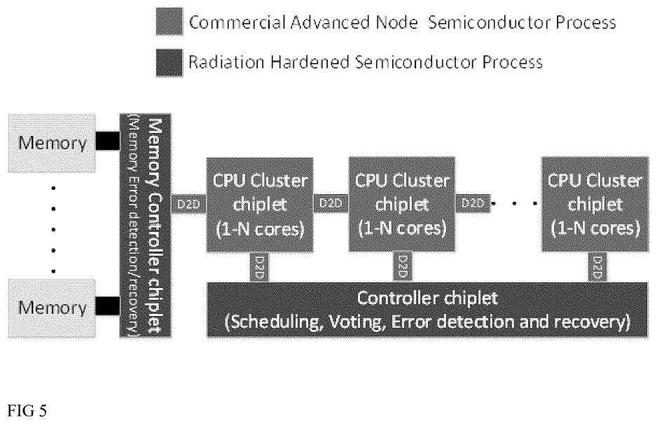

Another example use case where disaggregated IP (in chiplet form factor) from the Kenyi DPU+Host CPU can integrate to create a system is the space compute use case. Space computing (e.g. satellite computing) requires ever increasing compute power, but lags behind modern compute technologies because space electronics require expensive radiation hardened silicon processes that don't have the same performance as advanced commercial nodes. To mitigate this, redundant architectures that process the same workload across multiple CPU cores, and then vote on the outputs to detect errors from Single Event Transients (SEI) and Single Event Upsets (SEU), allow for COTS CPU's implemented in commercial advanced processes to be leveraged with only the voting circuitry implemented in radiation hardened processes. A similar approach can be taken with chiplets where multiple CPU cluster chiplets can be integrated with a controller chiplet that can schedule redundant tasks across the clusters (using mechanisms similar to the Event Device as one example), and then monitor the CPU cluster outputs to vote on correctness and to detect and recover from SEI/SEU errors. Such a controller chiplet can be implemented in a radiation hardened process while the CPU cluster chiplets can be implemented in advanced commercial process nodes for performance. This approach can be extended to implement other error sensitive points in radiation hardened semiconductor processes while leaving functions that require scale and performance in advanced commercial processes (e.g. error checking memory controller implemented in radiation hardened process while memories remain in COTS advanced process nodes). FIG. 5 illustrates an example Fault Tolerant Chiplet CPU architecture with radiation hardened CPU controller and memory controller chiplets along with CPU cluster chiplets implemented in commercial advanced node semiconductor processes.

Math Processing using Fabric Extension Architecture. Software portability is an important requirement for VRAN systems. In particular, the DPDK BBDEV interface is an important open-source API for hardware accelerators that has been generally used for VRAN applications. One particular function that is typically required is the Maximum Likelihood Tree Search (MLD-TS) accelerator which accelerates the Maximum Likelihood LLR generation function listed in Table 2. Given that VRAN may be a virtualized system, hardware accelerators accessible through the BBDEV API can be adapted to support virtualized input/output functions. In this invention, a system is devised whereby a general-purpose CPU chiplet die is adapted for use in VRAN. VRAN requirements are satisfied by connecting the invention's DPU chiplet to a general-purpose CPU chiplet. The DPU chiplet architecture is adapted to facilitate Matrix Math Processing, which can be generalized to other accelerator functions. To layer additional processing elements on top of the CPU chiplet, the DPU chiplet architecture extends the CPU chiplet functionality to support processors that are virtualizable as an extension of the Host CPU processor (i.e. CPU chiplet) as well as processors that are shared hardware components (shared amongst Virtual Machines and/or Containers) that use Virtualized IO (e.g. SR-IOV, Scalable IOV) to virtualize access. This accomplished by first, linking the coherent fabric in the CPU chiplet to a coherent fabric in the DPU chiplet through a die-to-die interface. The die to die interface may be of the UCIe type.

Fabrics are a data network localized on the set of chiplets that provide data interchange between the processors and accelerators. In one embodiment, the fabric technology includes a form of shared memory management. The coherent fabric architecture refers to cache management protocols that prevent one CPU in the system from relying on data stored in cache memory data that in the data space has been overwritten or updated. In one embodiment, the coherent fabric is a memory management architecture where hardware in the memory caching agents (for example, caching agents in the CPUs comprising the set of chiplets) and hardware in the coherent fabric mechanism actively manage the state of the memory caches so that all caching agents in the system are utilizing a consistent view of the memory space that they are individually addressing through their local caches. Second, a matrix multiply hardware module or another HW acceleration module may be operatively attached to a non-coherent fabric with a module adapted to act as a back-to-back PCIe Root Complex and End Point for managing its configuration and control, that is, the RCIEP, Root Complex Integrated End Point and a Memory Management Unit (MMU) managing the virtual address conversion. Non-coherent fabrics refer to a fabric data interchange mechanism that permits components in the system to access memory directly. While this approach may introduce data consistency problems in general, the non-coherent fabric is better suited to certain algorithms due to the particularities of data access sequences for the algorithm coupled with higher performance typically observed for this memory access architecture.

The Fabric Extension Architecture may be adapted to provide the extension of processing in the CPU Host by extending memory coherency to processors implemented in the DPU. This is accomplished by connecting the DPU Coherent Fabric that links to the CPU coherent fabric (601) through a die-to-die interface (606) over which memory snooping protocols run that feed memory management hardware. A controller can be mated to the die-to-die (D2D) interface to support different memory access protocols (e.g. PCIe, CHI Cip2Chip). The Die-to-Die (D2D) interfaces typically serialize data transfers over a high speed interface that can be synchronous or asynchronous. This extension creates a zone between the CPU and the DPU where the data memory space is reliably coherent, and thus usable for a wide range of software applications. The fabric extension architecture may also be adapted to permit the system to operate virtualized IO accelerators implemented in the DPU that connect to the Non-Coherent Fabric. In one embodiment the accelerator may be accessed with a control plane data interface module for control plane functions. These virtualized IO accelerators may rely on the back-to-back PCIe Root Complex/Endpoint module (603) for PCIe control plane functions (e.g. BAR setup, Virtualized IO) and the memory management unit (MMU) for data plane address translation. (607). The PCIe Root Complex/Endpoint module (603) implements control plane functions that does not need to support wide, high-speed buses for data transfer. The latter memory accesses go through the MMU path (607).

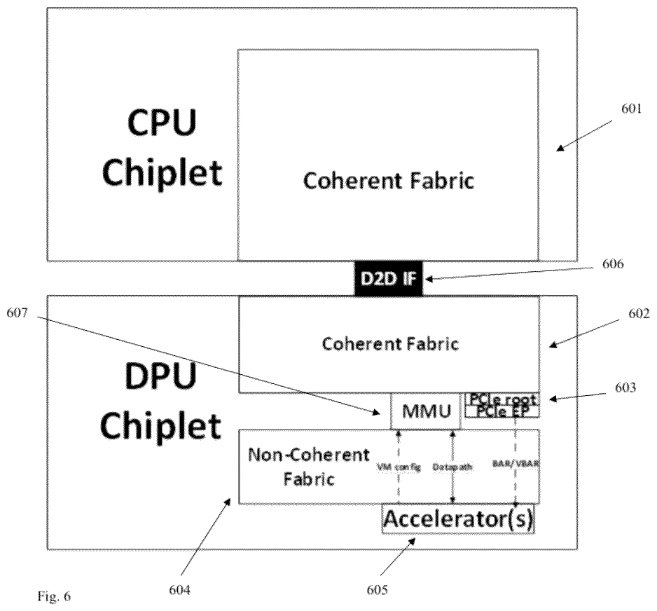

In one embodiment, an MMU (Memory Management Unit) that is situated between the coherent fabric (602) and the non-coherent fabric (604), (see FIG. 6) converts addresses to and from virtual to physical addresses. The MMU (607) is used to manage data transfer between the accelerator and the physical memory. For instance, the Host CPU and the CPUs comprising the DPU can be allocated amongst virtual machines (VM), each VM being an isolated environment where SW running in the VM accesses resources dedicated to it. One such resource is memory, and with regard to these CPUs, physical memory is addressed through the coherent fabric. The coherent memory space is physical, but the accelerator works with virtual addresses that need to be translated to a physical address in the coherent fabric (601, 602). So when a CPU in a virtualized system accesses memory in its virtual address space, the memory address has to be converted to a physical address for where the CPU's physical memory resides in the physical memory address map. If a CPU in this coherent zone of the VM gives a command to access a shared accelerator (605) that is connected to the system through the non-coherent fabric (604), that access is facilitated by that MMU, see FIG. 6.

The non-coherent fabric (604) provides the connectivity between the shared accelerator (605) and the MMU (607). Both the VM addressing by the accelerator and the data transfer passes over the non-coherent fabric. A command by a CPU that includes address of the data for the accelerator to process, that address will be a virtual address. When the accelerator has a command to fetch the data it presents the virtual address to the MMU which converts it to the physical address in the coherent fabric. The MMU likewise converts addresses when the accelerator is storing data. The data will reside at this physical address but will be passed back to and from the accelerator across the non-coherent fabric. Each CPU also has an internal MMU module in it for accessing the coherent fabric. When the CPU accesses the Virtual address space to populate the data for the accelerator to process, its internal MMU will convert from virtual to physical address. The operating system (for example, hypervisor) is responsible for allocating physical memory to the VM's and setting up the MMUs to do the conversion.

For the configuration of the system, the shared accelerators (605) will behave like a PCIe attached device for SW running in the CPU Host controlled by a PCIe Root Complex controller and PCIe Endpoint controller directly connected and integrated into the same module (603). This is to mimic RCIEP functionality (Root Complex Integrated Endpoint) on the coherent fabric (602). The system is adapted so that the control information flowing from the PCIe Endpoint is delivered to the accelerator (605). With these controllers integrated, the Host SW drivers in the OS Kernel and/or Hypervisor and/or User Space will configure the PCIe Endpoint controller with address mapping control information (i.e. BAR, VBAR), and that mapping information then gets fed to the accelerators (605). This address mapping information allows an accelerator to resolve which accesses through both the fabrics are targeted to it, as well as which Virtual Machine it came from. The accelerator (605) uses this information to configure the MMU (607) to translate its own Virtual address accesses to memory that are controlled by the MMU. The MMU uses this information to translate virtual address space (i.e. VM) to the Physical memory address space.

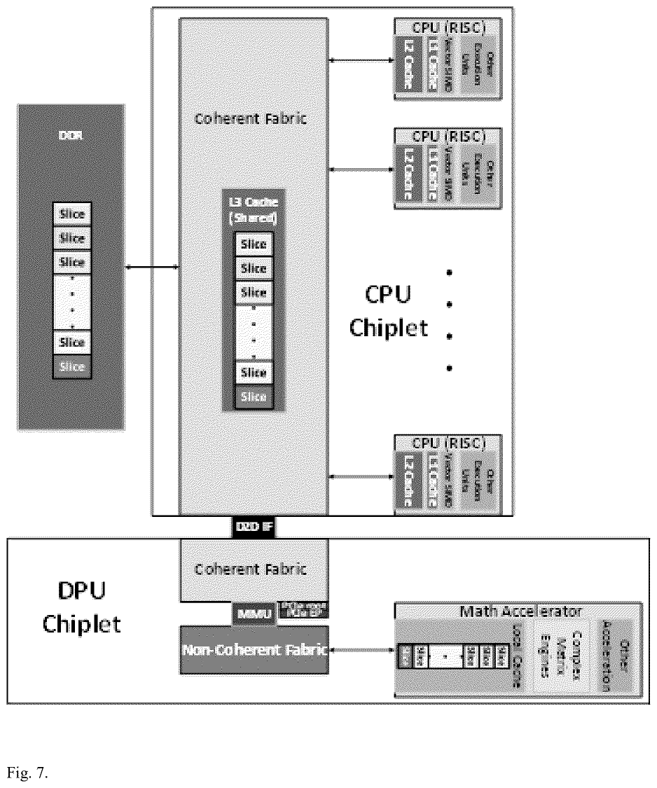

The fabric extension architecture may further utilize shared hardware accelerators. With the Fabric Extension Architecture, a shared hardware accelerator for Matrix Math processes and search processes can be implemented in the DPU and connected to the Non-Coherent Fabric as shown in FIG. 7. In one embodiment, the DPU Math Accelerator, coupled with the Fabric Extension Architecture will present as a Virtualized IO device to the CPU Host with the PCIe Root Complex/Endpoint module providing control (e.g. SR-IOV configuration) and the MMU between the Non-Coherent and Coherent fabrics providing address translation from Virtual to Physical addresses. By use of the fabric extension architecture with the DPU, the system is adapted to operate with a full offload of Matrix and Search algorithms. In some embodiments, the hardware accelerator can perform other kinds of off-loaded calculation processes. In another embodiment, the system architecture utilizes more efficient RISC CPU cores to reside in the CPU chiplet, while offloading compute intensive math and search calculations to the DPU.

In yet another embodiment the DPU operating as a Math Accelerator will operate the BBDEV interface protocol for current Matrix Math and search functions. In one variation the MLD-TS is implemented and operated. Further, the system will operate data transfers between the Host CPU chiplet and the DPU hardware accelerator (in the between L3 cache in the Coherent Zone and the shared hardware accelerator. This direct cache to/from accelerator data movement relaxes the load on DDR memory that is connected to the CPU Host. The shared hardware accelerator architecture facilitates efficiency through accelerator offload while maintaining software portability by supporting an open API. In addition, further software portability is achieved by executing the matrix math processing as an extended part of the CPU Host in the Coherency Zone that is further attached to the DPU Coherent Fabric.

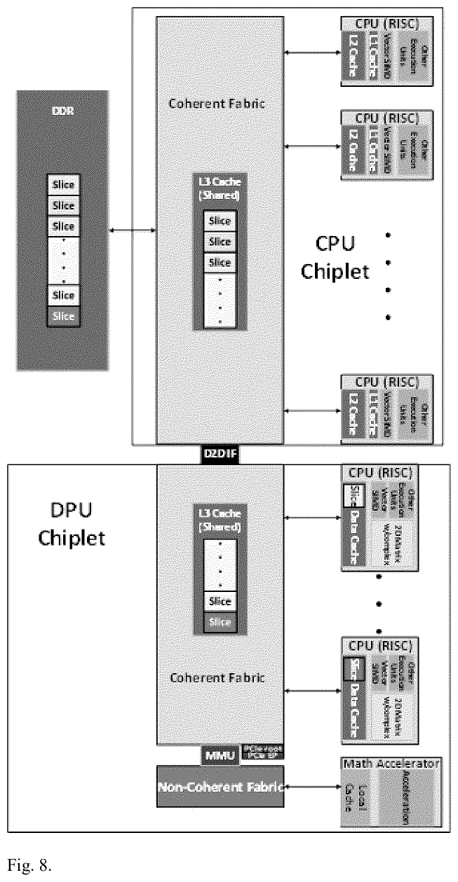

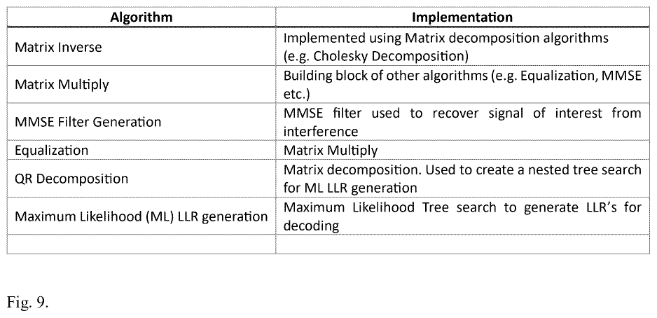

Typically, a CISC based VRAN system utilizes matrix processing in CPU's that are enabled with matrix extensions sitting on a coherent fabric with full coherence between caches and DDR memory. However, this approach can be improved by means of the inventions's DPU architecture. In this approach, the system architecture is adapted to separate the matrix math processing and search processing between a shared hardware accelerator module and CPU core modules adapted to operate matrix math functions, whereby both modules interact with the coherent fabric operated by the DPU that comprises the coherent zone. See FIG. 8. This adaptation extends the coherent fabric of the CPU Host processing into the DPU. These CPU core modules can be optimized for matrix processing by supporting virtualized host features (e.g. address translation, cache), while scaling down and tailoring its processing pipelines to embedded matrix processing operations. Several of these matrix processing operations are described in FIG. 9. Some of these operations may include an ARM core operating SME, and/or a RISC-V core with matrix extensions typically used for AI NPU. Complex data types can also be implemented with such options.

In some embodiments, the design of the DPU is modified by setting the number of CPU cores that optimizes the processing for specific applications. For example, the DPU is comprised of a predetermined number of CPUs and a hardware accelerator accessed through the MMU controlling the non-coherent fabric connection. In this manner, the CPU Host processing requirements are satisfied efficiently because not every CPU core in the system is burdened with matrix extension hardware. In addition, software portability is improved by leveraging abstraction layers for the matrix extensions such as extensions to Google Highway or SIMDe or similar libraries that include the RISC-V ecosystem in the abstraction framework. Further, different functions may be implemented in hardware or virtualized in software depending on the application. In some embodiments of the invention, more frequently used matrix processes may be implemented in the hardware accelerator while lesser used ones can operate as virtual processes on the DPU cores adapted for that purpose. For example, the MLD-TS API in BBDEV is implemented by the shared hardware accelerator whereas other functions recited in FIG. 9 can be implemented in software operating on the tailored CPU cores in the DPU that are connected to the DPU coherent fabric.

### Operating Environment:

The system is typically comprised of a central server that is connected by a data network to a user's computer. The central server may be comprised of one or more computers connected to one or more mass storage devices. The precise architecture of the central server does not limit the claimed invention. Further, the user's computer may be a laptop or desktop type of personal computer. It can also be a cell phone, smart phone or other handheld device, including a tablet. The precise form factor of the user's computer does not limit the claimed invention. Examples of well-known computing systems, environments, and/or configurations that may be suitable for use with the invention include, but are not limited to, personal computers, server computers, hand-held computers, laptop or mobile computer or communications devices such as cell phones, smart phones, and PDA's, multiprocessor systems, microprocessor-based systems, set top boxes, programmable consumer electronics, network PCs, minicomputers, mainframe computers, distributed computing environments that include any of the above systems or devices, and the like. Indeed, the terms “computer,” “server,” and the like may be used interchangeably herein, and may refer to any of the above devices and systems.

The user environment may be housed in the central server or operatively connected to it remotely using a network. In one embodiment, the user's computer is omitted, and instead an equivalent computing functionality is provided that works on a server. In this case, a user would log into the server from another computer over a network and access the system through a user environment, and thereby access the functionality that would in other embodiments, operate on the user's computer. Further, the user may receive from and transmit data to the central server by means of the Internet, whereby the user accesses an account using an Internet web-browser and browser displays an interactive web page operatively connected to the central server. The server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space displayed by the browser have different URL's. That is, the webpage encoding the simulated space can be a unitary data structure, but different URL's reference different locations in the data structure. The user computer can operate a program that receives from a remote server a data file that is passed to a program that interprets the data in the data file and commands the display device to present particular text, images, video, audio and other objects. In some embodiments, the remote server delivers a data file that is comprised of computer code that the browser program interprets, for example, scripts. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In one embodiment, a user's computer can run an application that causes the user's computer to transmit a stream of one or more data packets across a data network to a second computer, referred to here as a server. The server, in turn, may be connected to one or more mass data storage devices where the database is stored. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two respective remote computers to exchange information by means of digital network communication. As a result a data message can be one or more data packets transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In addition, the user's computer may obtain data from the server that is considered a website, that is, a collection of data files that when retrieved by the user's computer and rendered by a program running on the user's computer, displays on the display screen of the user's computer text, images, video and in some cases outputs audio. The access of the website can be by means of a client program running on a local computer that is connected over a computer network accessing a secure or public page on the server using an Internet browser or by means of running a dedicated application that interacts with the server, sometimes referred to as an “app.” The data messages may comprise a data file that may be an HTML document (or other hypertext formatted document file), commands sent between the remote computer and the server and a web-browser program or app running on the remote computer that interacts with the data received from the server. The command can be a hyper-link that causes the browser to request a new HTML document from another remote data network address location. The HTML can also have references that result in other code modules being called up and executed, for example, Flash, scripts or other code. The HTML file may also have code embedded in the file that is executed by the client program as an interpreter, in one embodiment, Javascript. As a result a data message can be a data packet transmitted from or received by a computer containing a destination network address, a destination process or application identifier, and data values or program code that can be parsed at the destination computer located at the destination network address by the destination application in order that the relevant data values or program code are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, a relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. In some embodiments, data stored in memory may be stored in the memory device, or an external mass data storage device like a disk drive. In yet other embodiments, the CPU may be running an operating system where storing a data set in memory is performed virtually, such that the data resides partially in a memory device and partially on the mass storage device. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. For example, the CPU may obtain two data values from memory and the logic in the CPU determine whether they are the same or not. Based on such Boolean logic result, the CPU then selects a first or a second location in memory as the location of the next step in the program execution. This type of program control flow may be used to program the CPU to determine data, or select a data from a set of data. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades or brightness. The user interface may also display a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a two dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

In some instances, especially where the user computer is a mobile computing device used to access data through the network the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), any form of 802.11.xx or Bluetooth.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Javascript, C, C++, JAVA, or HTML or scripting languages that are executed by Internet web-browser) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, binary components that, when executed by the CPU, perform particular tasks or implement particular abstract data types and when running, may generate in computer memory or store on disk, various data structures. A data structure may be represented in the disclosure as a manner of organizing data, but is implemented by storing data values in computer memory in an organized way. Data structures may be comprised of nodes, each of which may be comprised of one or more elements, encoded into computer memory locations into which is stored one or more corresponding data values that are related to an item being represented by the node in the data structure. The collection of nodes may be organized in various ways, including by having one node in the data structure being comprised of a memory location wherein is stored the memory address value or other reference, or pointer, to another node in the same data structure. By means of the pointers, the relationship by and among the nodes in the data structure may be organized in a variety of topologies or forms, including, without limitation, lists, linked lists, trees and more generally, graphs. The relationship between nodes may be denoted in the specification by a line or arrow from a designated item or node to another designated item or node. A data structure may be stored on a mass storage device in the form of data records comprising a database, or as a flat, parsable file. The processes may load the flat file, parse it, and as a result of parsing the file, construct the respective data structure in memory. In other embodiment, the data structure is one or more relational tables stored on the mass storage device and organized as a relational database.

The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card, SD Card), or other memory device, for example a USB key. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., a disk in the form of shrink wrapped software product or a magnetic tape), preloaded with a computer system (e.g., on system ROM or fixed disk), or distributed from a server, website or electronic bulletin board or other communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. Where the disclosure refers to matching or comparisons of numbers, values, or their calculation, these may be implemented by program logic by storing the data values in computer memory and the program logic fetching the stored data values in order to process them in the CPU in accordance with the specified logical process so as to execute the matching, comparison or calculation and storing the result back into computer memory or otherwise branching into another part of the program logic in dependence on such logical process result. The locations of the stored data or values may be organized in the form of a data structure.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

1. A computing system for off-loading compute intensive processes from a host CPU subsystem comprised of:
A first module operating as a first coherent fabric, said module operatively connected to a memory management module that interfaces with a non-coherent fabric;
An accelerator processor module operatively attached to the non-coherent fabric; and
A control plane data interface module in communication with the accelerator processor module and in communication with the first coherent fabric module.

2. The computer system of claim 1 where the hardware accelerator module is adapted to perform matrix math calculations.

3. The computer system of claim 1 where the hardware accelerator module is adapted to perform cryptographic calculations.

4. The computer system of claim 1 where the hardware accelerator module is adapted to perform artificial intelligence calculations.

5. The computer system of claim 1 where the hardware accelerator module is adapted to perform digital signal processing calculations.

6. The computer system of claim 2 where the matrix math calculations are comprised of matrix multiplications.

7. The computer system of claim 1 where the control plane data interface module is adapted to operate the PCIe control functions.

8. The computer system of claim 1 further comprised of:
At least one of the host multi-core CPU cores operatively connected to the first coherent fabric.

9. The computer system of claim 1 further comprised of:
a second coherent fabric module;
at least one of the host multi-core CPU cores operatively connected to the second coherent fabric; and
a D2D interface connecting the first coherent fabric to the second coherent fabric.

10. The computer system of claim 8 further comprised of a physical data memory interface operatively connected to the first coherent fabric.

11. The computer system of claim 9 further comprised of a physical data memory interface operatively connected to the second coherent fabric.

12. The computer system of claim 9 where the first coherent fabric module is housed in a first chiplet and the second coherent fabric module is housed in a second chiplet and the D2D interface communicates between the first chiplet and the second chiplet.

13. The computer of claim 9 further comprising:
A first physical data memory interface operatively connected to the first coherent fabric module; and
A second physical data memory interface operatively connected to the second coherent fabric module.

14. The computer system of claim 8 where the at least one host multi core CPU core is comprised of a RISC processor type.

15. The computer system of claim 8 where the at least one host multi core CPU core is comprised of a CISC processor type.

16. The computer system of claim 9 where the at least one host multi core CPU core is comprised of a RISC processor type.

17. The computer system of claim 9 where the at least one host multi core CPU core is comprised of a CISC processor type.

18. The computing system of claim 1 further comprising a queuing module adapted to manage task descriptors and dataflows between the host CPU and the DPU and manage arbitration of data flows into and out of the at least one accelerator blocks by operating an interface protocol between the host CPU subsystem and the queuing module and between the queuing module and the at least one accelerator blocks, said module further adapted to operate the interface protocol to pass processing requests from the host CPU subsystem to the at least one accelerator blocks.

19. The computing system of claim 18 whereby the queuing module operates the interface protocol by using at least one corresponding queue data structure comprised of data encoding processing requests from the host CPU to the corresponding at least one accelerator blocks.

20. The computing system of claim 18 where the at least one accelerator blocks are further adapted for dual use Wireless Baseband acceleration and AI/ML acceleration.

21. The computing system of claim 18 where the at least one accelerator blocks are further adapted for execution of cryptographic algorithms.

22. The computing system of claim 18 in the form of a first chiplet device, said first chiplet device operatively connected to a second chiplet device, said second chiplet device comprised of a host CPU, said first device and second device housed in a single integrated circuit package.

23. The computing system of claim 18 whereby the queueing module is further comprised of management logic for each VF that manages QOS, notifications and statistics, as well as a series of queues to buffer and dejitter the pointers, descriptors, data and status between the shared functions implemented in the DPU and the processing in the VM/Container.

24. A method to transfer data performed by a computer system comprised of a CPU, accelerator module, coherent fabric, non-coherent fabric and MMU comprising:
Transmitting from the CPU to a control plane interface module configuration data;
Receiving at the control plane interface module the configuration data by utilizing the coherent fabric;
Transmitting the configuration data from the control plane interface module to the accelerator module;
Transmitting from the accelerator module to the MMU the configuration data. Receiving at the MMU a data read request from the accelerator module, said data read request comprised of an address comprised of a VM address; and
Using the MMU to translate the VM address to a physical address that references a data storage location in a physical memory by use of the received configuration data.

25. A method to transfer data performed by a computer system comprised of a CPU, accelerator module, coherent fabric, non-coherent fabric and MMU comprising:
Transmitting from the CPU to a control plane interface module;
Receiving at the control plane interface module the configuration data by utilizing the coherent fabric;
Transmitting the configuration data from the control plane interface module to the accelerator module;
Transmitting from the accelerator module to the MMU the configuration data. Receiving at the MMU a data write request from the accelerator module, said request comprised of an address comprised of a VM address;
Using the MMU to translate the VM address to a physical address that references a data storage location in a physical memory by use of the received configuration data;
Transmitting from the accelerator a write data; and
Storing at the physical memory the write data at the physical address.

26. A computing system for off-loading compute intensive processes from a host CPU subsystem comprised of:
A first module operating as a first coherent fabric, said module operatively connected to a memory management module that interfaces with a non-coherent fabric;
An accelerator processor module operatively attached to the non-coherent fabric;
A control plane data interface module in communication with the accelerator processor module and in communication with the first coherent fabric module, said control plane data interface module adapted to receive configuration data by utilizing the coherent fabric, and transmit to the accelerator module the configuration data; and
A MMU operatively connected to the non-coherent fabric, said MMU configured to:
receive the configuration data from the accelerator module, receive a data read request from the accelerator module, said data read request comprised of an address comprised of a VM address, and translate the VM address to a physical address by use of the received configuration data.
